(19) United States
(12) Patent Application Publication
(10) Pub. No.: US 2003/0119394 A1
(43) Pub. Date: Jun. 26, 2003

(54) Nonwoven web with coated superabsorbent

(76) Inventors: Sridhar Ranganathan, Suwanee, GA (US); Gabriel Hamman Adam, Alpharetta, GA (US); Leon Eugene Chambers JR., Marietta, GA (US); Paul Windsor Estey, Cumming, GA (US); Eric Edward Lennon, Roswell, GA (US); Shannon Kathleen Melius, Appleton, WI (US); Debra Jean McDowall, Neenah, WI (US); William G. Reeves, Appleton, WI (US); Susan Elaine Shawver, Roswell, GA (US)

Correspondence Address: PAULEY PETERSEN KINNE & ERICKSON, 2800 WEST HIGGINS ROAD, SUITE 365, HOFFMAN ESTATES, IL, 60195, US

(21) Appl. No.: 10/036,864

(22) Filed: Dec. 21, 2001

(51) Int. Cl. B32B 5/02

(52) U.S. Cl. 442/79; 604/381; 442/86

(57) ABSTRACT

A nonwoven composite web contains coated superabsorbent and binder, such as thermoplastic staple fibers. The nonwoven composite web is easily made, economical, and has good distribution of materials, high absorbent particle loading, saturation capacity and flexibility.

### BACKGROUND OF THE INVENTION

Personal care products typically are made with a top sheet material (also referred to as a cover sheet or liner), an absorbent core and a liquid impervious back sheet. Some may also have a surge layer or other specialized layers between the top sheet and absorbent core. Absorption of fluid, comfort and avoidance of leakage are the functions desired.

Absorbent composite webs typically comprise absorbent materials and optionally synthetic fibers, binders or other active ingredients. The absorbent webs may comprise fibers to provide the structure and optionally contribute to absorbency. Additionally, superabsorbents may be added to the web to increase the absorbency effectiveness of the webs on a unit mass basis. Such webs are well known in the prior art. The amount of superabsorbent, especially particulate, that can be added into a web is limited by the fact that holding the particulates in place, especially when the absorbent is wet, is a challenge. Further, as the amount of superabsorbent added to the absorbent structure increases, the webs need to be highly compressed to hold the structure together, causing increased stiffness and a drop in permeability.

In addition, the swelling of high levels of superabsorbent weakens an absorbent structure, leading to poor integrity for the structure during use. A structure that distorts or breaks during wear is uncomfortable to the wearer and may not function effectively to absorb bodily excretions. Increasing the amount of superabsorbent in a web leads to beneficial properties such as a thin structure that is more comfortable for the user, more discrete (in the case of feminine products, children's training pants, and adult incontinence products) and more visually desirable (in the case of infant diapers).

In nonwoven airlaid materials, as known in the art, nonwoven web constituents are entrained into an air stream and deposited on a forming wire, or web, and subsequently fixed in place by various means, such as heating. However, uniform entrainment of the various constituent materials is often problematic. The thermoplastic fibers, thermoplastic binders, cellulosic or other absorbent fibers, and superabsorbent materials, may come in a variety of forms, such as substantially continuous fibers, staple fibers and particulates. The constituent materials may further be in a variety of weights, sizes and morphologies, as will be known to those of skill in the art.

Various methods have been proposed to alleviate uneven deposition of constituent materials for the nonwoven web onto the forming wire. One such method, often called a Dan-Web process, is exemplified in U.S. Pat. No. 4,640,810, to Laursen et al., in which the constituent materials are air-entrained through two perforate screen chambers, or tubular forming screens, located inside a forming head. The forming screens have particle-distributing rotary members therein for dispersing the constituent materials through the screens into the forming head and onto the forming wire. U.S. Pat. No. 5,885,516, to Christensen et al., teaches a similar system of particle distribution but with superabsorbent powder being distributed by a separate chute located between the forming screens and substantially at the bottom thereof. It has been found that achieving the proper mix of air currents to obtain uniform distribution of the materials in such systems can be problematic. Particulate constituent materials such as the superabsorbents, may especially be caused to aggregate towards the middle of the web, leading to wasted materials, or unsatisfactory performance for use in personal care absorbent articles. Other problems may include long process equilibrium times resulting from particulate build-up in the forming pipes and excessive equipment wear due to the abrasive nature of certain particulates.

As mentioned, absorbent articles are typically formed from such materials as hydrophilic fibers, absorbent polymers, binder materials, and the like. Bicomponent fibers are a desirable type of binder fiber and may be used to bind an absorbent structure into a stable form by heating a structure containing the binder fibers above the melting point of the lower melting of the two polymers that compose the bicomponent fiber. Bicomponent nonwoven filaments are known in the art generally as thermoplastic filaments which employ at least two different polymers combined together in a heterogeneous fashion. Instead of being homogeneously blended, two polymers may, for instance, be combined in a side-by-side configuration, so that a first side of a filament is composed of a first polymer “A” and a second side of the filament is composed of a second polymer “B.” Alternatively, the polymers may be combined in a sheath-core configuration, so that an outer sheath layer of a filament is composed of a first polymer “A,” and the inner core is composed of a second polymer “B.” Other heterogeneous configurations are also possible.

Pulp fibers have been employed in certain absorbent applications to enhance the absorbency. U.S. Pat. No. 4,530,353, issued to Lauritzen, discloses pulp fibers in combination with staple length bicomponent fibers used in the manufacture of absorbent bandages. In that case, the fibers also contain high and low melting polymers. The staple length fibers are bonded together by melting only the lower melting component.

There is a need or desire for an absorbent nonwoven web composite which exhibits good softness and strength with a high degree of absorbency. There is a further need to achieve a high degree of absorbent particle loading in a nonwoven web to economically and efficiently make highly absorbent webs for personal care absorbent articles. There is a further need for improved integrity of the absorbent structure during use. There is still a further need for an absorbent structure that is able to effectively handle both simple fluids, such as urine, and complex fluids, such as runny feces and menses. This need exists for diapers, training pants, wipes, and other personal care absorbent articles where comfort, strength, and absorbent performance are all important.

### SUMMARY OF THE INVENTION

In response to the discussed difficulties and problems encountered in the prior art a new composite web has been discovered which may provide a combination of a high degree of absorbent materials by weight within the web, high wet integrity, good absorbent containment, and favorable mechanical properties, especially during wear. Personal care products using the resultant webs are also contemplated to be within the scope of this invention. In one aspect, this invention addresses a means to increase the superabsorbent content for purposes of comfort, discretion, and consumer appeal while simultaneously improving the integrity of the product during use.

One such personal care product has a liquid impermeable backsheet, a liquid permeable topsheet, and the multifunctional composite web located between the topsheet and backsheet. The composite material web, hereinafter sometimes referred to simply as the web, according to one embodiment of the present invention is a coformed web having major surfaces in the X-Y plane and a depth in the Z direction that is suitable for use as a fluid retention layer in a disposable absorbent article.

The web may contain a layer or layers of airlaid composite material which may have both binders and absorbent material. The binder may be staple or continuous fibers. The binder may be thermoplastic staple fibers such as spunbond or meltblown fibers. The thermoplastic fibers may be single component or multi-component fibers of various composition and may be present in amount of greater than or equal to about two weight percent in a web of binder fibers and absorbent materials.

The absorbent materials desirably include particles of coated superabsorbent. The coating material may include natural materials such as cellulosic materials, e.g., staple fibers of wood pulp, bound to particles of superabsorbent materials in a combination of the natural and superabsorbent materials, and may be present in amounts of less than or equal to about ninety eight weight percent in a web. The web may be provided with other layers such as forming tissues, films, or the like as desired for the ultimate application of the web. Without wishing to be bound by theory, it is thought that using coated superabsorbents in a web rather than its uncoated form provides better containment due to mechanical entanglement of the particles within the web. The coating is also believed to provide separation between particles that helps maintain a better structure from a liquid handling perspective. The coating can also separate and adsorb the particulate components of runny feces and menses, enhancing the performance of the superabsorbent with these difficult-to-absorb complex fluids.

A method of achieving a web according to the present invention may include: passing the thermoplastic fibers, as entrained in an airstream, through tubular forming screens contained inside a forming head, the tubular forming screens having rotating distribution members within the tubular forming screens; and adding particles of the coated superabsorbent within the forming head outside of, and above, the tubular forming screens to avoid interrupting the air flow within the forming head which might lead to uneven distribution of the web components. In another aspect of the present invention the method may include passing the thermoplastic fibers entrained in an airstream through tubular forming screens contained inside a forming head, and adding the coated superabsorbent within the forming head outside of, and above, the tubular forming screens via a chute to avoid disrupting the air flow within the forming head.

Another method of achieving a web according to the present invention involves using a coform process, in which at least one meltblown diehead is arranged near a chute through which other materials are being added. Coform processes are described in U.S. Pat. No. 4,818,464 to Lau and U.S. Pat. No. 4,100,324 to Anderson et al. The meltblown fibers may be derived from polymers such that they have a degree of stretch properties. Suitable polymers are described in PCT publication WO 00/31331. The benefits of having stretch properties to the web include improved product fit and less restriction of superabsorbent swelling.

A suitable web composition may be had with a homogenous mixture of binder and particles of coated superabsorbent, wherein the particles of coated superabsorbent serve as the primary absorbent material for the web. The particles of superabsorbent material may include about 20% to 97% superabsorbent material and about 3% to 80% coating by weight. The coating of the superabsorbent particles may be cellulose, adsorbent silicates, zeolites or other functional entities. Examples of cellulose coatings are fibrillated Birch pulp such food, grade Excel 110 (Functional Foods, Elizabeth Town, N.J.), Sulfatate HJ (Rayonier, Jesup, Ga.). Examples of other coatings are Zeofree 5175A, which is a man-made silicate available from J. M. Huber Corporation, Havre de Grace, Md., and Silkleer 25M and Ryolex 39, which are mined, processed perlite materials available from Silbrico Corporation, Hodgkins, Ill.

The binder may be thermoplastic fibers such as bicomponent staple fibers of PE/PET, bicomponent staple fibers of PE/PP; meltblown fibers including, but not limited to, polypropylene, LLDPE, single site catalyzed PE, styrenic block copolymer and blends, polyether amides, polyether esters and polyurethanes. The binders suitably comprise greater than or equal to about two weight percent to about 40 weight percent of the web. The absorbent composite web may suitably have between about a 50 gsm and a 1500 gsm basis weight, depending on the end use, and include between about 30 weight percent and about 98 weight percent coated superabsorbent material. Other raw materials such as pulp, un-coated superabsorbent, odor control agents or other entities may also be incorporated into the web. Optionally, the web can be formed onto a support member to carry the web through the process. The support member can provide additional integrity to the absorbent composite. The support web may also provide other benefits such as intake or distribution of fluid during use. The support member may comprise a spunbond or meltblown nonwoven web, tissue or pulp web, or other suitable material. While certain numbers have been suggested to exemplify aspects of the present invention, the person of skill in the art will realize that the percentages or ratios of binder fibers to absorbent material will be selected based upon the purpose to which the absorbent web is ultimately put.

### BRIEF DESCRIPTION OF THE DRAWINGS

FIG. 1 is a schematic diagram of a first aspect of the present invention showing a Dan-Web type forming head with distribution means for absorbent particulates outside of, above, and upstream of the distribution screens.

FIG. 2 is a schematic diagram of a second aspect of the present invention showing a Dan-Web type forming head with distribution means for absorbent particulates outside of, above, upstream and downstream of the distribution screens.

FIG. 3 is a schematic diagram of a third aspect of the present invention showing a Dan-Web type forming head with distribution means for absorbent particulates outside of, upstream of, and tangential to the forming screens.

FIG. 4 is a schematic diagram of a fourth aspect of the present invention showing a Dan-Web type forming head with distribution means for absorbent particulates outside of, upstream and downstream of, and tangential to the forming screens.

FIG. 5 illustrates one embodiment of a nonwoven web according to the present invention.

### DEFINITIONS

“Disposable” includes being disposed of after a single, or limited, use and not intended to be washed and reused.

A “layer” is defined as having a homogeneous composition and density, within typical process variability for nonwoven structures. Alternatively a layer may contain patterns within itself, such as stripes, apertures or waves. “Layer” when used in the singular may have the dual meaning of singular or plural elements.

“Composite” is defined as having two or more components and may consist of one or more layers. These may be either homogeneous or heterogeneous.

“Particle,” “particles,” “particulate,” “particulates” and the like, refer to a material that is generally in the form of discrete units. The particles can include granules, pulverulents, powders or spheres. Thus, the particles can have any desired shape such as, for example, cubic, rod-like, polyhedral, spherical or semi-spherical, rounded or semi-rounded, angular, irregular, etc. Shapes having a large greatest dimension/smallest dimension ratio, like needles, flakes and fibers, are also contemplated for use herein. The use of “particle” or “particulate” may also describe an agglomeration including more than one particle, particulate or the like.

As used herein, “caliper” is the thickness of a web measured under a 0.2 psi (1.38 kPa) restraining pressure. Caliper can be measured wet or dry.

“Absorbent capacity” refers to the maximum volume of liquid that can be absorbed by a material as measured by the saturation capacity test.

As used herein and in the claims, the term “comprising” is inclusive or open-ended and does not exclude additional unrecited elements, compositional components, or method steps.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the useful fiber diameters are usually expressed in microns. (Note that to convert from osy to gsm, multiply osy by 33.91).

“Spunbond fibers” refers to small diameter fibers that are formed by extruding molten thermoplastic material as filaments from a plurality of fine capillaries of a spinneret. Such a process is disclosed in, for example, U.S. Pat. No. 3,802,817 to Matsuki et al., U.S. Pat. No. 4,340,563 to Appel et al. The fibers may also have shapes such as those described, for example, in U.S. Pat. No. 5,277,976 to Hogle et al. which describes fibers with unconventional shapes.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin et al. Meltblown fibers are microfibers which may be continuous or discontinuous, are generally smaller than 10 microns (μm) in average diameter, and are generally tacky when deposited onto a collecting surface.

The term “substantially continuous filaments” or “substantially continuous fibers” refers to filaments or fibers prepared by extrusion from a spinneret, including without limitation spunbond and meltblown fibers, which are not cut from their original length prior to being formed into a nonwoven web or fabric. Substantially continuous filaments or fibers may have average lengths ranging from greater than about 15 cm to more than one meter, and up to the length of the nonwoven web or fabric being formed. The definition of “substantially continuous filaments” (or fibers) includes those filaments or fibers which are not cut prior to being formed into a nonwoven web or fabric, but which are later cut when the nonwoven web or fabric is cut.

The term “staple fibers” means fibers which are natural or cut from a manufactured filament prior to forming into a web, and which commonly have an average length ranging from about 0.1-15 cm, more commonly about 0.2-7 cm.

“Superabsorbent,” “superabsorbent material” and the like are intended to refer to a water-swellable, water-insoluble organic or inorganic material capable, under the most favorable conditions, of absorbing at least about 10 times its weight and, preferably, at least about 15 times its weight in an aqueous solution containing 0.9 weight percent of sodium chloride.

“Airlaying” is a well-known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive. Airlaying is taught in, for example, U.S. Pat. No. 4,640,810 to Laursen et al. Airlaying may include coform deposition which is a known variant wherein pulp or other absorbent fibers are deposited in the superabsorbent material air stream onto the forming screen. The screen may also be referred to herein as a forming wire.

“Personal care product” means diapers, wipes, training pants, absorbent underpants, adult incontinence products, feminine hygiene products, wound care items like bandages, surgical drapes and other articles.

Words of degree, such as “about”, “substantially”, and the like are used herein in the sense of “at, or nearly at, when given the manufacturing and material tolerances inherent in the stated circumstances” and are used to prevent the unscrupulous infringer from unfairly taking advantage of the invention disclosure where exact or absolute figures are stated as an aid to understanding the invention.

As used herein, the term “machine direction” or MD means the length of a fabric in the direction in which it is produced. The term “cross direction” or “cross machine direction” or CD means the width of fabric, i.e. a direction generally perpendicular to the MD.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, solvents, particulates, and materials added to enhance processability of the composition.

### DETAILED DESCRIPTION

Absorbent webs according to one aspect of the present invention may include coated superabsorbents between 30% and 98% by weight to yield a high capacity, strong and flexible absorbent that has high integrity both wet and dry. In another aspect, the web may include coated superabsorbents and synthetic staple binder fibers to stabilize the web. In another aspect, the web may include coated superabsorbent and meltblown fibers. In another aspect, superabsorbent material that is not coated may also be added to enhance the performance of the web. In yet another aspect, natural or synthetic fibers may also be added to further enhance capillarity, wet resiliency or other desired properties.

The absorbent webs of this invention may be made using the airlaid process. The production of airlaid nonwoven composites is well defined in the literature and documented in the art. Examples include the Dan-Web process as described in U.S. Pat. No. 4,640,810, to Laursen et al., assigned to Scan Web of North America Inc., and U.S. Pat. No. 5,885,516, to Christensen et al., assigned to Scan Web I/S of Denmark; the Kroyer process as described in U.S. Pat. No. 4,494,278, to Kroyer et al., and U.S. Pat. No. 5,527,171, to Soerensen, assigned to Niro Separation a/s, the method of U.S. Pat. No. 4,375,448, to Appel et al., assigned to Kimberly-Clark Corporation, or other similar methods.

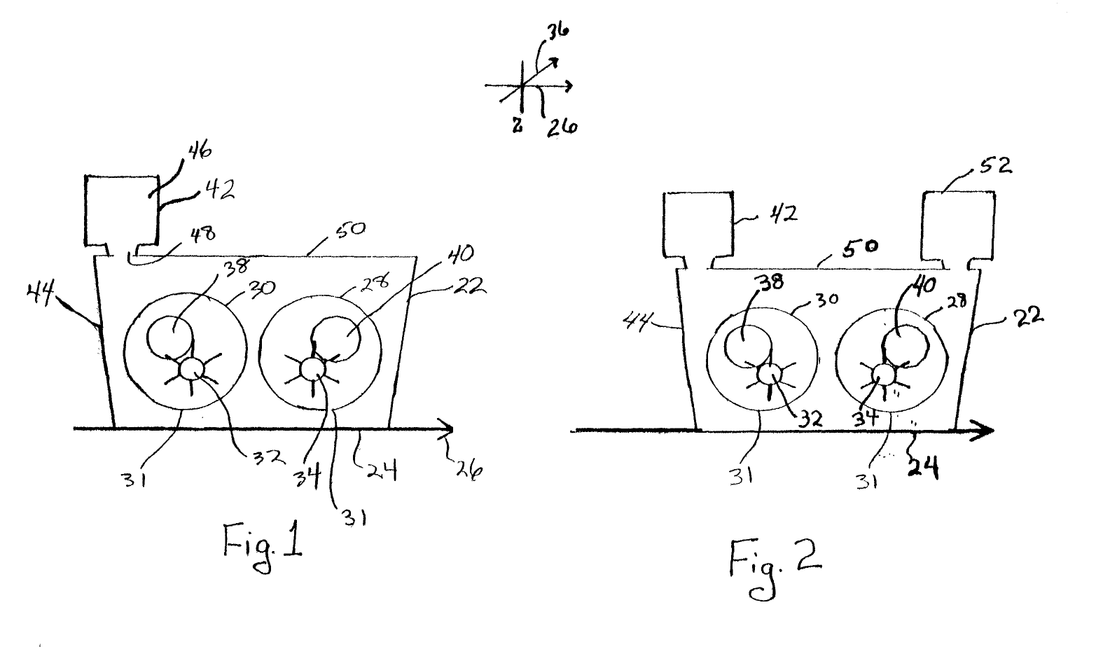

As seen in FIG. 1, a cross sectional view of a Dan-Web type head modified according to one aspect of the present invention, a forming head 22 is placed above a foraminous forming wire 24. The wire 24 collects the deposited web components discharged by the forming head 22 and moves in the machine direction 26 as indicated by arrows. A Dan-Web type forming head will overlay the wire 24 and extend across the width, or cross machine direction 36 of the wire. The forming head 22 contains two tubular forming screens 28, 30 having rotating distribution members 32, 34, one within each of the tubular forming screens 28, 30. The forming screens 28, 30 have a lower, or bottom-most surface, or point, 31 and may themselves rotate. The web component thermoplastic fibers and cellulosic fibers are entrained in an airstream and fed through openings 38, 40 into the rotating tubular forming screens 28, 30 contained inside the forming head 22, to be distributed by the rotating distribution members 32, 34 back out through the forming screens and onto the wire 24.

The adding of particles, such as those of a coated superabsorbent, within the forming head 22 is done via a separate distribution unit 42 outside of the tubular forming screens 28, 30 at a location upstream in the MD, of the tubular forming screens, desirably at or near the upstream edge 44 of the forming unit 22. The reader is referred to co-pending application [docket KCC-16075] filed concurrently herewith for further edification concerning the addition of particulates to the web. The distribution unit 42 may for example have a hopper 46 and outlet 48 which extend across the CD of the forming head 22 to deposit particles of coated superabsorbent via a roller (not shown) through the top 50 of the forming head. One suitable distribution unit may be a particle feeder from Christy Machine Co. of Fremont Ohio.

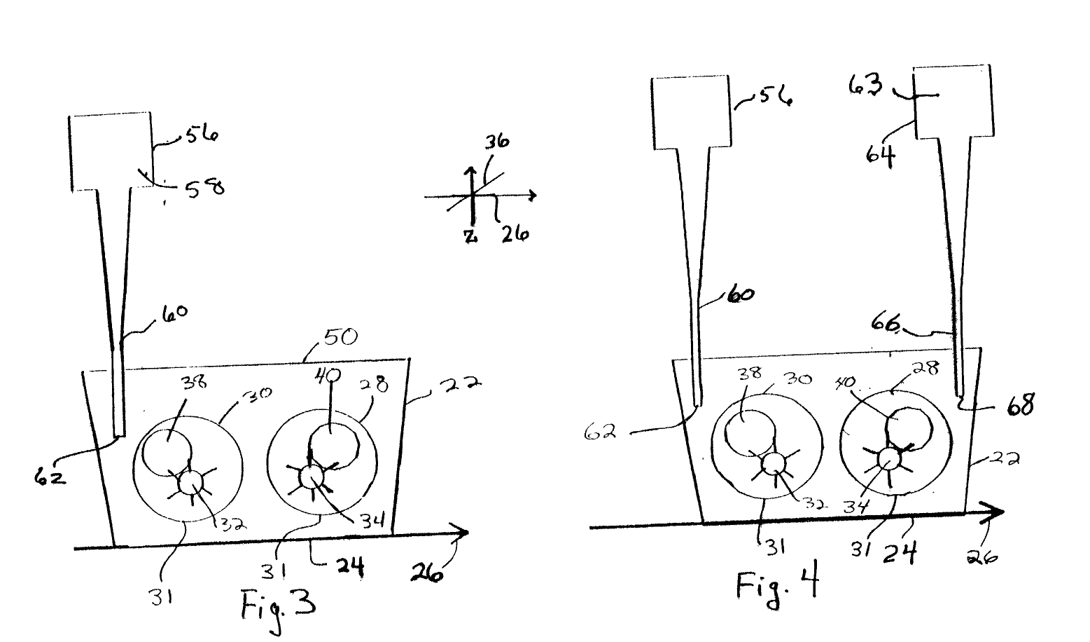

Referencing FIG. 2, an aspect of the present invention is shown wherein the particles of coated superabsorbent are added via both an upstream distribution unit 42 and a downstream distribution unit 52. The upstream distribution unit 42 and the downstream distribution unit 52 may operate to meter the flow of the particles of coated superabsorbent and may be operated concurrently, sequentially, or otherwise, such as to vary the amount, type, or placement of the particulates within the web.

By not sifting the particles of coated superabsorbent through the forming screens 28, 30 less particulate matter will be lost, particulate matter distribution will be made more even across the web, and equipment wear will be less. Further process enhancements may include quicker operation equilibrium times.

In one instance, absorbent composites made according to the apparatus of FIG. 1 were nonwoven webs varying between 142 to 336 gsm basis weight such as that listed as example 1 in the table below. KoSa Type 255 thermoplastic binder fiber was entrained to the forming screens 28, 30 while coated superabsorbent material particulates consisting of 66% Stockhausen Favor 880 particulate superabsorbent and 34% EXCEL 110, a powdered cellulose available from Functional Foods, Elizabethtown, N.J. were added through the separate distribution unit 42 at a ratio of about 7% and 93%, respectively, thereby obtaining an overall superabsorbent material loading or weight percent, in the finished web of about 60%. The web was subsequently bonded, or fixed, in a hot air impingement oven at about 320 degrees F.

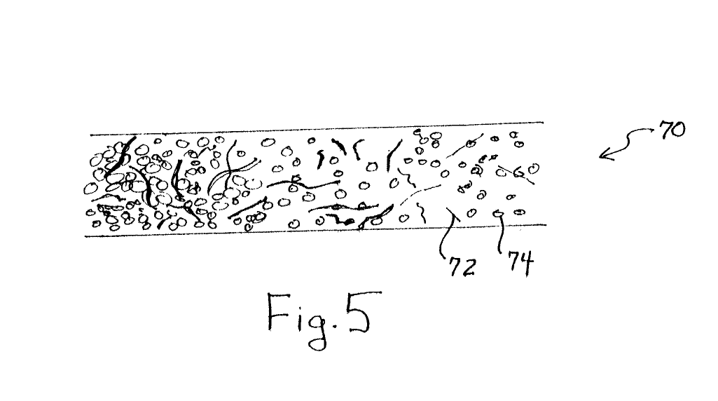

The resultant web 70, as schematically illustrated in FIG. 5 to show the dry thermoplastic staple binder fibers 72 and particles of coated superabsorbent 74, had high wet integrity, high capacity and good flexibility as shown in Table below.

| | | | Saturated | | Edge |
|---|---|---|---|---|---|
| Sample | | Density | Capacity | Wet Tensile | compression |
| Description | | (g/cc) | (g/g) | (g/gsm/in) | (g/gsm) |
| 1. | Coated SAP | 0.22 | 20.4 | 1.16 | 0.29 |
| | composite | | | | |
| 2. | SAM/fluff | 0.22 | 14.5 | 0 | 1.24 |
| 3. | Airlaid | 0.15 | 15.3 | 1.27 | 2.89 |
| | SAM/pulp/binder | | | | |

The person having ordinary skill in the art will note high saturated capacity, good wet tensile strength and low edge compression for inventive example number 1 as compared to the comparative examples of numbers 2 and 3. The sample number 2, referred to as SAM/fluff, is an airformed superabsorbent/pulp absorbent extracted from a commercial Huggies® Ultratrim Step 3 diaper. The sample number 3, referred to as Airlaid SAM/pulp/binder, is an absorbent formed on a Dan-Web line with 40 weight percent Favor® 880 superabsorbent, 57% NB416 pulp, 3% T255 binder fiber.

Referencing FIG. 3, a cross sectional view of a Dan-Web type head modified according to other aspects of the present invention, a forming head 22 is placed above a foraminous forming wire 24. As in the previous figures, the wire 24 collects the deposited web components discharged by the forming head 22 and moves in the machine direction 26 as indicated by arrows. The forming head overlays the wire 24 and extends across the width, or cross machine direction 36 of the wire. The forming head 22 contains two tubular forming screens 28, 30 having rotating distribution members 32, 34, one within each of the tubular forming screens 28, 30. The web component thermoplastic fibers are entrained in an airstream and fed through openings 38, 40 into the tubular forming screens 28, 30 contained inside the forming head 22, to be distributed onto the wire 24.

The adding of particles of coated superabsorbent within the forming head 22 is done via a separate distribution unit 56 including a metering distribution unit 58 and a placement chute 60 for placing the particulates into the forming head 22. The chute 60 may suitably have an outlet 62 outside of the tubular forming screens 28, 30 at a location upstream in the MD of the tubular forming screens, at or near the upstream edge 44 of the forming unit 22 and above the bottom-most surface 31 of the screens 28, 30. The metering distribution unit 58 and the chute 60 may extend across the CD of the forming head 22 to deposit particles of coated superabsorbent through the top 50 of the forming head. One suitable metering distribution unit may be a particle feeder from Christy Machine Co. of Fremont Ohio.

Referencing FIG. 4, an aspect of the present invention is shown wherein the particles of coated superabsorbent are added via both an upstream distribution unit 56 and a downstream distribution unit 64. The downstream distribution unit 64 will also suitably have a metering distribution unit 63 and a chute 66 having an outlet 68 placed above the bottom of the screens 28, 30. Placement of the particles of coated superabsorbent within the forming head 22 via the chutes 60, 66 will help isolate the particulate addition stream and keep it from disrupting, or being disrupted by, the flow of components coming from the screens 28, 30. The upstream distribution unit 56 and the downstream distribution unit 64 may operate to meter the flow of the particles of coated superabsorbent and may be operated concurrently, sequentially, or otherwise, such as to vary the amount, type, or placement of the particulates within the web.

Preferred binder fibers for inclusion in the webs of the present invention are those having a relatively low melting point such as polyolefin fibers. Lower melting point polymers provide the ability to bond the fabric together at fiber cross-over points upon the application of heat. In addition, fibers having a lower melting polymer, like conjugate bicomponent and biconstituent fibers are suitable for practice of this invention. Fibers having a lower melting polymer are generally referred to as “fusible fibers”. By “lower melting polymers” what is meant are those having a crystalline melting point less than about 175 degrees C. Exemplary binder fibers include conjugate bicomponent fibers of polyolefins, polyamides and polyesters. Some suitable binder fibers are sheath core conjugate fibers available from KoSa Inc. (Charlotte, N.C.) under the designation T-255 and T-256 or copolyester designation, though many suitable binder fibers are known to those skilled in the art, and are available by many manufacturers such as Chisso Corporation, Osaka, Japan, and Fibervisions LLC of Wilmington, Del. The coating of the coated superabsorbent particles may be so constructed as to be receptive to microwave or radio frequency (RF) electromagnetic radiation. These energy receptive coatings could function to absorb microwaves and, through dielectric heating, melt or soften binder fibers present in the web, thus providing integrity to the web. Such energy receptive coatings may be, for example, carbon black, magnetite, silicon carbide, calcium chloride, zircon, ferrite, tin oxide, alumina, magnesium oxide, and titanium dioxide. The dielectric heating allows the matrix polymer to reach its melting temperature much more rapidly than it would without the energy receptive coating and allows fiber bonding in the web to occur at a faster rate than without the coating.

Suitable cellulosic wood pulps may include standard softwood fluffing grade such as CR-1654 (US Alliance Pulp Mills, Coosa, Ala.). Pulp may be modified in order to enhance the inherent characteristics of the fibers and their processability. Curl may be imparted to the fibers by methods including chemical treatment or mechanical twisting. Curl is typically imparted before crosslinking or stiffening. Pulps may be stiffened by the use of crosslinking agents such as formaldehyde or its derivatives, glutaraldehyde, epichlorohydrin, methylolated compounds such as urea or urea derivatives, dialdehydes such as maleic anhydride, non-methylolated urea derivatives, citric acid or other polycarboxylic acids. Some of these agents are less preferable than others due to environmental and health concerns. Pulp may also be stiffened by the use of heat or caustic treatments such as mercerization. Examples of these types of fibers include NHB416 which is a chemically crosslinked southern softwood pulp fibers which enhances wet modulus, available from the Weyerhaeuser Corporation of Tacoma, Wash. Other useful pulps are fully debonded pulp (NF405) and non-debonded pulp (NB416) and PH Sulfite pulp, also from Weyerhaeuser. HPZ3 from Buckeye Technologies, Inc. of Memphis, Tenn., has a chemical treatment that sets in a curl and twist, in addition to imparting added dry and wet stiffness and resilience to the fiber. Another suitable pulp is Buckeye HPF2 pulp and still another is IP SUPERSOFT® from International Paper Corporation.

The superabsorbent materials can be natural, synthetic and modified natural polymers and materials. Typically, superabsorbent materials are lightly crosslinked water soluble materials. The term “cross-linked” refers to any means for effectively rendering normally water-soluble materials substantially water insoluble but swellable. Such means can include, for example, physical entanglement, crystalline domains, covalent bonds, ionic complexes and associations, hydrophilic associations, such as hydrogen bonding, and hydrophobic associations or Van der Waals forces. In addition, the superabsorbent materials can be modified with inorganic materials, such as silica gels. Examples of superabsorbent materials include, but are not limited to, hydrogel-forming polymers which are alkali metal salts of: poly(acrylic acid); poly(methacrylic acid); copolymers of acrylic and methacrylic acid with acrylamide, vinyl alcohol, acrylic esters, vinyl pyrrolidone, vinyl sulfonic acids, vinyl acetate, vinyl morpholinone and vinyl ethers; hydrolyzed acrylonitrile grafted starch; acrylic acid grafted starch; maleic anhydride copolymers with ethylene, isobutylene, styrene, and vinyl ethers; polysaccharides such as carboxymethyl starch, carboxymethyl cellulose, methyl cellulose, and hydroxypropyl cellulose; poly(acrylamides); poly(vinyl pyrrolidone); poly(vinyl morpholinone); poly(vinyl pyridine); and copolymers and mixtures of the above. The hydrogel-forming polymers are preferably lightly cross-linked to render them substantially water-insoluble. Cross-linking may be achieved by irradiation or by covalent, ionic, van der Waals attractions, or hydrogen bonding interactions, for example. A desirable superabsorbent material is a lightly cross-linked hydrocolloid. Specifically, a more desirable superabsorbent material is a partially neutralized polyacrylate salt. Mixtures of natural and wholly or partially synthetic superabsorbent polymers can also be useful in the present invention. Other suitable absorbent gelling materials are disclosed by Assarsson et al. in U.S. Pat. No. 3,901,236 issued Aug. 26, 1975. Processes for preparing synthetic absorbent gelling polymers are disclosed in U.S. Pat. No. 4,076,633 issued Feb. 28, 1978 to Masuda et al. and U.S. Pat. No. 4,286,082 issued Aug. 25, 1981 to Tsubakimoto et al.

Superabsorbent materials may be xerogels which form hydrogels when wetted. The term “hydrogel,” however, has commonly been used to also refer to both the wetted and unwetted forms of the superabsorbent polymer material. Superabsorbent materials can be in many forms such as flakes, powders, particulates, and fibers. The particles can be of any desired shape, for example, spiral or semi-spiral, cubic, rod-like, polyhedral, etc. Needles, flakes, fibers, and combinations may also be used. The reader is referred to PCT Application WO 00/62922 (U.S. application Ser. No. 09/546,634, priority date Apr. 16, 1999) for embodiments of coated superabsorbent materials known in the art. Copending application (attorney docket KCC-16,537), filed concurrently herewith, describes particularly suitable coated superabsorbents for use in this invention.

### TEST METHODS

To determine density, a sample of the tested material of a known area is taken and its thickness (under 0.2 psi) and mass are measured. Dividing the mass by the sample's volume (area * thickness) yields density.

Wet Tensile Strength

The peak load in g/gsm/in, that can be supported by a web, is determined by employing the following tensile test method. The test sample has a width of 1 inch (2.54 cm), and a length of 3 inch (7.62 cm). The grips attached on the sample have a smooth rubberized surface and are at least the width of the sample (1 inch) and were arranged with an initial separation distance of 1 inch (2.54 cm). The cross-head speed of the constant rate of extension tester was 30.48 cm/min. Prior to placement in the apparatus the weight of the web is measured. The test sample is then submerged in a 0.9 percent saline solution for 30+/−5 seconds to ensure wet-out of the structure. The peak load is measured. The reported value is the peak load in g per gsm of material per inch width of material.

Edge Compression

Edge compression is used herein as a measure of the dry stiffness (or flexibility) of the sample. The method by which the Edge-wise Compression (EC) value can be determined is set forth in U.S. Pat. No. 6,323,388.

Saturated Capacity Test Method

This test is used to measure the absorbent capacity of a composite. A detailed description of the test method and the require apparatus are found in U.S. Pat. No. 5,192,606 to Proxmire et al.

As will be appreciated by those skilled in the art, changes and variations to the invention are considered to be within the ability of those skilled in the art. Such changes and variations are intended by the inventors to be within the scope of the invention.

We claim:

1. An airlaid composite absorbent web comprising a homogenous mixture of binder and particles of coated superabsorbent.

2. The airlaid composite absorbent web according to claim 1 wherein the particles of coated superabsorbent material comprise from about 30% to about 97% superabsorbent material and from about 70% to about 3% cellulose fiber or other materials.

3. The airlaid composite absorbent web according to claim 1 wherein the binder comprises less than about 40 weight percent of the web.

4. The airlaid composite absorbent web according to claim 1 wherein the binder comprises less than about 20 weight percent of the web.

5. The airlaid composite absorbent web according to claim 1 wherein the binder comprises less than about 10 weight percent of the web.

6. The airlaid composite absorbent web according to claim 3 wherein the binder is a thermoplastic fiber.

7. The airlaid composite absorbent web according to claim 6 wherein the thermoplastic fibers are bicomponent fibers.

8. The airlaid composite absorbent web according to claim 6 wherein the thermoplastic fibers are PE/PET staple fibers.

9. The airlaid composite absorbent web according to claim 3 wherein the binder comprises meltblown fibers.

10. The airlaid composite absorbent web according to claim 1 wherein the binder comprises elastomeric fibers.

11. The airlaid composite absorbent web according to claim 10 wherein the elastomeric fibers comprise a polymer selected from the group including styrene-isoprene-styrene block copolymers, styrene-butadiene-styrene block copolymers, styrene-ethylene/butylene-styrene block copolymers, styrene-ethylene/-propylene-styrene block copolymers, polyurethanes, elastomeric polyamides, elastomeric polyesters, elastomeric polyolefin homopolymers and copolymers, atactic polypropylenes, ethylene vinyl acetate copolymers, single-site or metallocene catalyzed polyolefins having a density less than about 0.89 grams/cc, and combinations thereof.

12. The airlaid composite absorbent web according to claim 1 wherein the absorbent composite web is between about 50 gsm and about 1500 gsm basis weight.

13. The airlaid composite absorbent web according to claim 1 wherein the absorbent composite web comprises greater than or equal to about 2 weight percent thermoplastic binder fiber and less than or equal to about ninety eight weight percent particles of coated superabsorbent.

14. The airlaid composite absorbent web according to claim 13 further comprising between about 30 weight percent and about 85 weight percent coated superabsorbent material.

15. The airlaid composite absorbent web according to claim 1 further comprising at least one of non-coated superabsorbent materials, pulp fibers, synthetic fibers, odor control agents, and other natural or synthetic materials.

16. The airlaid composite absorbent web according to claim 1 wherein the absorbent composite web has an absorbent capacity of between about 15 g/g and about 40 g/g.

17. The airlaid composite absorbent web according to claim 1 wherein the composite absorbent web has a density of between about 0.1 g/cc and about 0.5 g/cc.

18. An airlaid composite absorbent web comprising a homogenous mixture of binder and particles of cellulose-coated superabsorbent.

19. The airlaid composite absorbent web according to claim 18 wherein the particles of cellulose-coated superabsorbent material comprise from about 30% to about 97% superabsorbent material and from about 70% to about 3% cellulose fiber.

20. The airlaid composite absorbent web according to claim 18 wherein the binder comprises less than about 40 weight percent of the web.

21. The airlaid composite absorbent web according to claim 18 wherein the binder comprises less than about 20 weight percent of the web.

22. The airlaid composite absorbent web according to claim 18 wherein the binder comprises less than about 10 weight percent of the web.

23. The airlaid composite absorbent web according to claim 20 wherein the binder comprises thermoplastic fibers.

24. The airlaid composite absorbent web according to claim 23 wherein the thermoplastic fibers are bicomponent fibers.

25. The airlaid composite absorbent web according to claim 23 wherein the thermoplastic fibers are PE/PET staple fibers.

26. The airlaid composite absorbent web according to claim 20 wherein the binder comprises meltblown fibers.

27. The airlaid composite absorbent web according to claim 18 wherein the binder comprises elastomeric fibers.

28. The airlaid composite absorbent web according to claim 27 wherein the elastomeric fibers comprise a polymer selected from the group including styrene-isoprene-styrene block copolymers, styrene-butadiene-styrene block copolymers, styrene-ethylene/butylene-styrene block copolymers, styrene-ethylene/-propylene-styrene block copolymers, polyurethanes, elastomeric polyamides, elastomeric polyesters, elastomeric polyolefin homopolymers and copolymers, atactic polypropylenes, ethylene vinyl acetate copolymers, single-site or metallocene catalyzed polyolefins having a density less than about 0.89 grams/cc, and combinations thereof.

29. The airlaid composite absorbent web according to claim 18 wherein the absorbent composite web is between about 50 gsm and about 1500 gsm basis weight.

30. The airlaid composite absorbent web according to claim 18 wherein the absorbent composite web comprises greater than or equal to about 2 weight percent thermoplastic binder fiber and less than or equal to about ninety eight weight percent particles of coated superabsorbent.

31. The airlaid composite absorbent web according to claim 30 further comprising between about 30 weight percent and about 85 weight percent coated superabsorbent material.

32. The airlaid composite absorbent web according to claim 18 further comprising at least one of non-coated superabsorbent materials, pulp fibers, synthetic fibers, odor control agents, and other natural or synthetic materials.

33. The airlaid composite absorbent web according to claim 18 wherein the absorbent composite web has an absorbent capacity of between about 15 g/g and about 40 g/g.

34. The airlaid composite absorbent web according to claim 18 wherein the composite absorbent web has a density of between about 0.1 g/cc and about 0.5 g/cc.

35. An airlaid composite absorbent web consisting essentially of a homogenous mixture of binder and particles of coated superabsorbent.

36. The airlaid composite absorbent web according to claim 35 wherein the particles of coated superabsorbent material comprise from about 30% to about 97% superabsorbent material and from about 70% to about 3% cellulose fiber.

37. The airlaid composite absorbent web according to claim 35 wherein the binder comprises less than about 40 weight percent of the web.

38. The airlaid composite absorbent web according to claim 35 wherein the binder matrial comprises less than about 20 weight percent of the web.

39. The airlaid composite absorbent web according to claim 35 wherein the binder comprises less than about 10 weight percent of the web.

40. The airlaid composite absorbent web according to claim 37 wherein the binder comprises thermoplastic fibers.

41. The airlaid composite absorbent web according to claim 40 wherein the thermoplastic fibers are bicomponent fibers.

42. The airlaid composite absorbent web according to claim 40 wherein the thermoplastic fibers are PE/PET staple fibers.

43. The airlaid composite absorbent web according to claim 37 wherein the binder comprises meltblown fibers.

44. The airlaid composite absorbent web according to claim 35 wherein the binder comprises elastomeric fibers.

45. The airlaid composite absorbent web according to claim 44 wherein the elastomeric fibers comprise a polymer selected from the group including styrene-isoprene-styrene block copolymers, styrene-butadiene-styrene block copolymers, styrene-ethylene/butylene-styrene block copolymers, styrene-ethylene/-propylene-styrene block copolymers, polyurethanes, elastomeric polyamides, elastomeric polyesters, elastomeric polyolefin homopolymers and copolymers, atactic polypropylenes, ethylene vinyl acetate copolymers, single-site or metallocene catalyzed polyolefins having a density less than about 0.89 grams/cc, and combinations thereof.

46. The airlaid composite absorbent web according to claim 35 wherein the absorbent composite web is between about 50 gsm and about 1500 gsm basis weight.

47. The airlaid composite absorbent web according to claim 35 wherein the absorbent composite web comprises greater than or equal to about 2 weight percent thermoplastic binder fiber and less than or equal to about ninety eight weight percent particles of cellulose-coated superabsorbent.

48. The airlaid composite absorbent web according to claim 35 further comprising between about 30 weight percent and about 85 weight percent cellulose-coated superabsorbent material.

49. The airlaid composite absorbent web according to claim 35 further comprising at least one of non-coated superabsorbent materials, pulp fibers, synthetic fibers, odor control agents, and other natural or synthetic materials.

50. The airlaid composite absorbent web according to claim 35 wherein the absorbent composite web has an absorbent capacity of between about 15 g/g and about 40 g/g.

51. The airlaid composite absorbent web according to claim 35 wherein the composite absorbent web has a density of between about 0.1 g/cc and about 0.5 g/cc.

52. An airlaid composite absorbent web consisting essentially of a homogenous mixture of binder and particles of cellulose-coated superabsorbent.

53. The airlaid composite absorbent web according to claim 52 wherein the particles of cellulose-coated superabsorbent material comprise from about 30% to about 97% superabsorbent material and from about 70% to about 3% cellulose fiber.

54. The airlaid composite absorbent web according to claim 52 wherein the binder comprises less than about 40 weight percent of the web.

55. The airlaid composite absorbent web according to claim 52 wherein the binder comprises less than about 20 weight percent of the web.

56. The airlaid composite absorbent web according to claim 52 wherein the binder comprises less than about 10 weight percent of the web.

57. The airlaid composite absorbent web according to claim 54 wherein the binder comprises thermoplastic fibers.

58. The airlaid composite absorbent web according to claim 57 wherein the thermoplastic fibers are bicomponent fibers.

59. The airlaid composite absorbent web according to claim 57 wherein the thermoplastic fibers are PE/PET staple fibers.

60. The airlaid composite absorbent web according to claim 54 wherein the binder comprises meltblown fibers.

61. The airlaid composite absorbent web according to claim 52 wherein the binder comprises elastomeric fibers.

62. The airlaid composite absorbent web according to claim 61 wherein the elastomeric fibers comprise a polymer selected from the group including styrene-isoprene-styrene block copolymers, styrene-butadiene-styrene block copolymers, styrene-ethylene/butylene-styrene block copolymers, styrene-ethylene/-propylene-styrene block copolymers, polyurethanes, elastomeric polyamides, elastomeric polyesters, elastomeric polyolefin homopolymers and copolymers, atactic polypropylenes, ethylene vinyl acetate copolymers, single-site or metallocene catalyzed polyolefins having a density less than about 0.89 grams/cc, and combinations thereof.

63. The airlaid composite absorbent web according to claim 52 wherein the absorbent composite web is between about 50 gsm and about 1500 gsm basis weight.

64. The airlaid composite absorbent web according to claim 52 wherein the absorbent composite web comprises greater than or equal to about 2 weight percent thermoplastic binder fiber and less than or equal to about ninety eight weight percent particles of cellulose-coated superabsorbent.

65. The airlaid composite absorbent web according to claim 64 further comprising between about 30 weight percent and about 85 weight percent cellulose-coated superabsorbent material.

66. The airlaid composite absorbent web according to claim 52 further comprising at least one of non-coated superabsorbent materials, pulp fibers, synthetic fibers, odor control agents, and other natural or synthetic materials.

67. The airlaid composite absorbent web according to claim 52 wherein the absorbent composite web has an absorbent capacity of between about 15 g/g and about 40 g/g.

68. The airlaid composite absorbent web according to claim 52 wherein the composite absorbent web has a density of between about 0.1 g/cc and about 0.5 g/cc.

69. The airlaid composite absorbent web according to claim 1 wherein the absorbent composite web further comprises a support member.

70. The airlaid composite absorbent web according to claim 69 wherein the support member comprises at least one of a spunbond web, a meltblown web, a nonwoven web, a tissue web or a pulp web.

71. The airlaid composite absorbent web according to claim 18 wherein the absorbent composite web further comprises a support member.

72. The airlaid composite absorbent web according to claim 71 wherein the support member comprises at least one of a spunbond web, a meltblown web, a nonwoven web, a tissue web or a pulp web.

73. The airlaid composite absorbent web according to claim 35 wherein the absorbent composite web further comprises a support member.

74. The airlaid composite absorbent web according to claim 73 wherein the support member comprises at least one of a spunbond web, a meltblown web, a nonwoven web, a tissue web or a pulp web.

75. The airlaid composite absorbent web according to claim 52 wherein the absorbent composite web further comprises a support member.

76. The airlaid composite absorbent web according to claim 75 wherein the support member comprises at least one of a spunbond web, a meltblown web, a nonwoven web, a tissue web or a pulp web.
